(19) United States
(12) Patent Application Publication
(10) Pub. No.: US 2024/0053725 A1
(43) Pub. Date: Feb. 15, 2024

(54) PARAMETERIZATION OF A DIGITAL TWIN AND/OR AN AUTOMATION SYSTEM

(71) Applicant: Jochen Bretschneider, Owingen (DE)

(72) Inventor: Jochen Bretschneider, Owingen (DE)

(21) Appl. No.: 18/232,350

(22) Filed: Aug. 9, 2023

(30) Foreign Application Priority Data
Aug. 10, 2022 (EP) 22189658.2

(51) Int. Cl. G05B 19/409; G05B 19/404; G05B 19/4063; G05B 19/408

(52) U.S. Cl. CPC G05B 19/409; G05B 19/404; G05B 19/4063; G05B 19/4083

(57) ABSTRACT

A method of providing output data for parameterizing a digital twin of an automation system is provided. The automation system includes a plurality of automation components. The digital twin is a digital representation of the automation system. The method includes determining, by an automation component from the plurality of automation components, parameter data from the plurality of automation components. The parameter data serves for parameterizing the digital twin of the automation system. The method includes creating, by the automation component, output data based on the parameter data. The output data is loadable by the digital twin of the automation system.

This application claims the benefit of European Patent Application No. EP 22189658.2, filed on Aug. 10, 2022, which is hereby incorporated by reference in its entirety.

### TECHNICAL FIELD

The present disclosure relates to the field of automation system and, more specifically, industrial automation systems such as machine tools. The present disclosure also relates to the virtualization of such automation systems such as digital twins, and, more specifically, the parameterization of the digital twin and/or the automation system.

### BACKGROUND

The digital twin simulates and optimizes all areas of the value-added chain: Product, production, and performance. This is the next step in the digital transformation for machine builders and users, allowing them to reach the next level of productivity. This provides that central processes in the production landscape (e.g., programming, production planning, and process optimization) are always simulated using the digital twin, which provides a detailed virtual image of the control system and/or machining process. The digital twin plays a decisive role when it comes to optimizing the widest range of processes while the machine is operational. Using the digital twin, a range of tasks may be shifted from the real world into the virtual world. For example, the digital twin for machining optimizes the utilization of machine tools. Unproductive machine periods are reduced to a minimum and consequentially shifted into production planning.

Programming and setting up operations are virtually shifted from the real production environment into a virtual environment. For example, a machine tool does not have to be at a standstill to identify whether components can be actually machined. Computer numerical control (CNC) programs may be tested in advance for potential collision of the tool with clamping equipment or machine parts. CNC programs for new production orders may be run-in “off-line” as long as the machine tool is still in productive operation. Further, new operating personal may be trained without blocking the machine. Unproductive times at the machine tool are therefore reduced to a minimum and consequentially shifted into production planning. This boosts the productivity and availability of the machine tool.

### SUMMARY AND DESCRIPTION

The present disclosure relates to the problem that a digital twin (DT) of an automation system, such as a CNC-controlled machine tool, including mechanical transmission elements, motors, drives, a CNC control, a programmable logic controller PLC) control, and a gateway, such as Sinumerik Edge, are to be parameterized by the user in a time-consuming manner. The necessity of a parameterization persists both at the time of an initial creation of the DT, which is usually carried out by the original equipment manufacturer (OEM), and at the time of the application at the end customer, for example, if a change of the automation system occurs due to re-parameterization, conversion, maintenance, repair, and replacement of components or wear, for example, of the mechanical transmission elements. While the automation system builder as an OEM usually knows exactly how the parameterization has to be done and has easy access to the parameters, the challenge for the end customer is much greater.

The scope of the present invention is defined solely by the appended claims and is not affected to any degree by the statements within this summary.

The present embodiments may obviate one or more of the drawbacks or limitations in the related art. For example, an accurate parameterization of a digital twin and/or an automation system is enabled.

The present disclosure proposes a solution for parameterization of a DT and/or an automation system. An automatic generation of the parameter data necessary for the simulation of an automation system, machine, or plant (e.g., at the request of the user) is provided. This may be achieved in a user-friendly manner by actuating a single button (e.g., virtual button) on the automation component of the automation system. In response to the push of a button on an automation component of the automation system, parameter data (e.g., a fingerprint data) of the automation system may be recorded in electronic form (e.g., in a file). This file may be directly loaded into the DT of the automation component.

### BRIEF DESCRIPTION OF THE DRAWINGS

FIG. 1 shows an illustration of a machine tool and a corresponding digital twin.

FIG. 2 shows a plurality of automation components of a machine tool.

FIG. 3 shows a transmission of parameter data from a machine tool to a digital twin.

FIG. 4 shows parameter data including settings and a data backup, respectively.

FIG. 5 shows a control display of a machine tool including a control element for creating output data.

FIGS. 6 to 17 show further embodiments.

### DETAILED DESCRIPTION

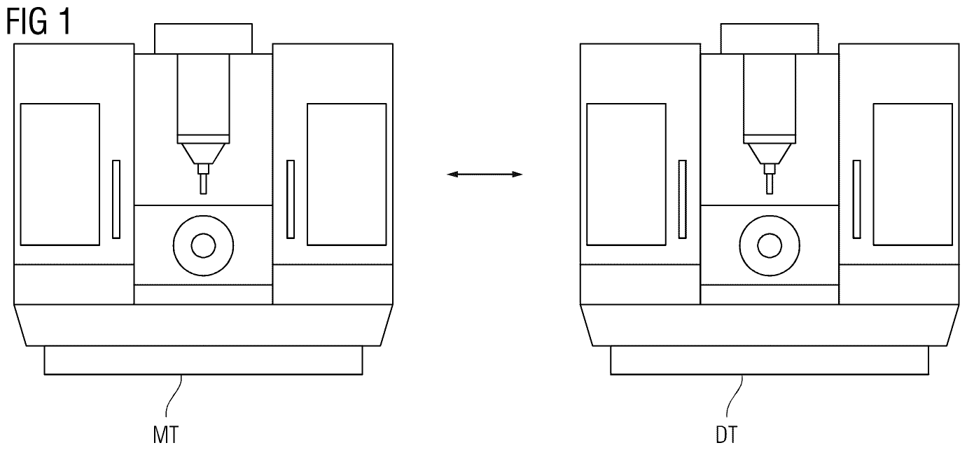

As an example of an automation system including a plurality of automation components 11-18, in hardware and/or software, a machine tool MT is shown in FIG. 1.

A machine tool MT is a machine for handling or machining a workpiece made of metal or other rigid materials, usually by cutting, boring, grinding, shearing, or other forms of deformations. A machine tool MT may employ a cutting tool that does the cutting or shaping. The machine tool MT may have some ways of constraining the workpiece and provide a guided movement of the parts of the machine tool MT. Thus, the relative movement between the workpiece and the cutting tool (e.g., the toolpath) is controlled or constrained by the machine tool MT to at least some extent.

Nowadays, an automated control of a machine tool MT by a computer (e.g., CNC; machine tool) is employed. To that end, coded programmed instructions (e.g., without a manual operator directly controlling the machining operation) are processed by the machine tool. Having the correct speeds and feeds in the program provides for a more efficient and smoother processing. Incorrect speeds and feeds will cause damage to the tool, machine spindle, and even the workpiece.

A digital twin DT is a virtual automation system that simulates an automation system (e.g., on a PC or other computing platform). The hardware and/or software components of the automation system are modeled in software, and may represent a complete image of a real automation system. With the digital twin DT, it is possible to develop and test the automation system (e.g., including a plurality of automation components such as a CNC machine, or NCK, PLC, and HMI software) without requiring any hardware. Parts of the machine tool MT commissioning may be preconfigured on the digital twin DT. Thereby, it is possible to significantly shorten the commissioning time of the real automation system by configuring the automation system using the digital twin.

For example, the digital twin may include a simulation of the numerical control kernel (NCK), the PLC, the HMI, the drive component, motor(s), and/or spindle(s). Further, the digital twin DT may include a simulation of the periphery of these components. The peripheral simulation for the simulation of the peripherals, such as actuators or sensors, may also be part of the digital twin DT. The peripheral simulation may allow writing PLC variables in the input image of the PLC and/or reading PLC variables in the input image of the PLC.

The digital twin DT allows the use of different machine tool configurations (e.g., turning machine (with/without Safety Integrated), or milling machine (with/without Safety Integrated)). The parameter data of different configurations may be created, configured, and/or saved. For example, it is possible to configure a PLC and all the associated modules using the digital twin, program the user logic of the PLC, and then load the hardware configuration and the PLC program into the digital twin. The program logic may then be executed by the digital twin, which allows monitoring of the responses/effects of the simulated inputs and outputs and adaption of the program logic. A virtual PLC (e.g., a digital twin) may not be able to fully simulate a real PLC. There may be differences in the behavior of a virtual PLC compared with a real PLC. It is thus necessary to have an up-to-date parameterization of the digital twin.

The digital twin DT may be executed on a computing platform such as a PC or a cloud platform. The digital twin DT may be run on a PC with Windows operating system. From there, the scan cycle time and the exact time of actions are not the same as if these actions would be performed on physical hardware. This is because on the PC, a number of programs share processing resources.

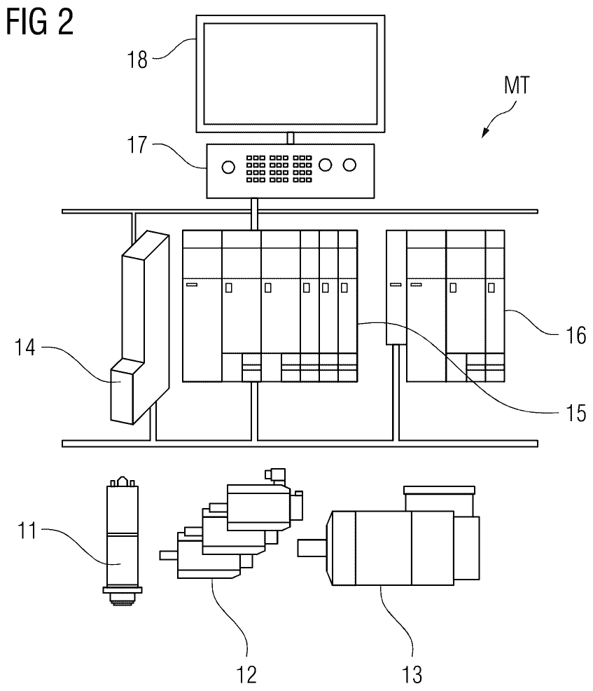

FIG. 2 shows a plurality of automation components 11-18 of a machine tool. The plurality of automation components 11-18 may include a hardware (e.g., a processor) and a software (e.g., a control program being executed by the processor in order to control the functioning of the automation component 11-18 and/or the automation system MT). For example, the PLC 16 may include a first program that controls the exchange of signals and data between the PLC 16 and the NC 17, HMI 18, and machine control panel components. The PLC 17 may include a second program that is machine-specific and/or application specific by which the first PLC basic program is extended.

Similarly, a drive component 15 of the automation system MT and the software of those components 11-18 may be configured. For example, an encoder of a drive component 15 may be selected and parameterized. Further, alarm settings (e.g., relating to a temperature of the drive component 18) may be set.

The plurality of automation components 11-18 may interact in order to control the automation system MT. For example, the PLC may interact with the CNC in order to transfer (e.g., cyclically transfer) axis and/or spindle 11 signals. These signals may influence the CNC inputs and/or output. The CNC may then in turn transfer signals representing the actual values or setpoints for controlling an axis or spindle 11.

Further, the automation system MT or automation component 11-18 may include a measuring system for monitoring one or more hardware components of the automation system MT or automation component 11-18. The measuring system may serve for monitoring of hardware faults (e.g., measuring system failure, wire breakage). Measuring system monitoring functions carried out in the drive component 15 may be mapped on an CNC alarm or CNC reaction (e.g., abort of referencing or on-the-fly measuring).

For example, Siemens offers automation systems MT such as the SINUMERIK NCU, which includes the following integrated subcomponents: PLC, NCK, CP, HMI (SINUMERIK Operate), SINAMICS Integrated (DRIVE). The operation of the Siemens NCU may be simulated in a virtual environment (e.g., using the Create MyVirtual Machine software also offered by Siemens).

A topology of the automation components 11-18 of a CNC-controlled machine tool MT with the automation components 11-18 to be taken into account for the parametrization of a DT is shown in FIG. 2. Now, in order to parameterize the DT of a machine tool MT, a user is to retrieve a large number of different parameter data from the machine tool MT, or initiate, carry out, and document measurements.

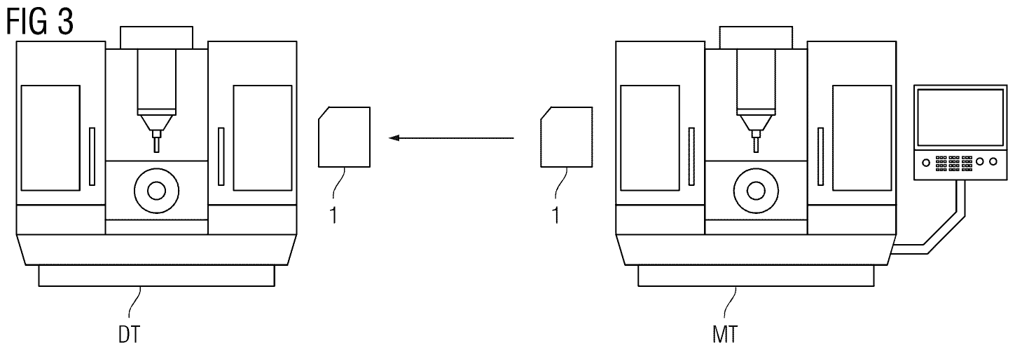

FIG. 3 shows a transmission of output data 1 (e.g., including parameter data 2) from a machine tool MT to a digital twin DT.

Adaptation of the control at the automation system MT (e.g., the machine tool) may be performed using the machine data and setting data. The machine data (MD) may include the following data: general machine data, channel-specific machine data, axis-specific machine data, parameters for the Control Unit, parameter for the infeed, drive parameters. The setting data (SD) may include the following data: general setting data, channel-specific setting data, axis-specific setting data.

One or more automation components may be selected, and the parameter data of those automation components may then be determined. During archive creation or a data backup, each selected component may appear as a progress bar. When all automation components have finished their actions, the status of each automation component may be displayed. If all automation components have stored their parameter data without errors, the output data is created. If there are errors, even of a single automation component, the output data may not be saved. Optionally, an error log may be displayed. In case the output data 1 is in the form of a file (e.g., on the automation system MT, such as the machine tool), the folder or file path may be preset or may be changed as desired.

In order to create the output data 1, a user may select a corresponding option (e.g., using a virtual button) in the operating menu of the automation system MT such as the machine tool. After selecting the virtual button and/or before selecting the button, the automation components of which the parameter data is to be retrieved may be selected. Additionally, a user may confirm the selection(s) made by further user input, and the output data may be created.

Further, one or more measurements (e.g., reference measurements) may be initiated and/or started and/or carried out in order to determine and/or update the parameter data 2. For example, the coordinate system of an axis of the machine tool MT may be synchronized with the coordinate system of the machine tool. The axis is traversed to the machine zero, and then, the actual position of the axis is set to zero. If the machine tool MT zero cannot be directly approached as a result of the machine design, then a reference point is defined in the traversing range of the axis, which is then used to synchronize the axis. Its position with reference to the machine tool zero is to be known. When referencing, the actual machine axis position is set to this value. When referencing, axes may be synchronized with any one of the following measuring systems and referencing types: Incremental rotary measuring system with at least one zero mark; incremental linear measuring system; rotary measuring system with distance coded reference marks; linear measuring system with distance coded reference marks; absolute rotary measuring system; absolute linear measuring system. The referencing methods may include any one of the following: Referencing with incremental measuring systems with proximity switch and one-edge and two-edge detection; referencing with incremental measuring systems with replacement of homing cam with proximity switch; referencing with incremental measuring systems with proximity switch with configured approach velocity for spindle applications; referencing with measuring systems with distance coded reference marks by overtravelling 2 or 4 zero marks; referencing of passive measuring systems using measuring system adjustment; referencing in follow-up mode; referencing with cam switch at the drive. For channel-specific referencing, all axes of the channel are referenced in the parameterized sequence when reference point approach is initiated. As soon as a measurement has been successfully completed (e.g., for all machine axes involved), this is acknowledged. As a result, the machine tool zero is updated and may be retrieved as part of the parameter data.

In general, a measurement may serve to improve the accuracy of the digital twin DT of the automation system MT. For example, backlash may occur within and/or outside the position control loop. Further, when traversing a circular path in a machine tool, contour errors occur primarily due to the reversal error and friction. During motion along straight lines, a contour error arises due to a reversal error outside the position control loop (e.g., due to a tilting milling spindle). This causes a parallel offset between the actual and the set contour. The shallower the gradient of the straight line, the larger the offset. Accordingly, the parameter data may include data entries that reflect (e.g., a friction compensation) a backlash compensation or the like.

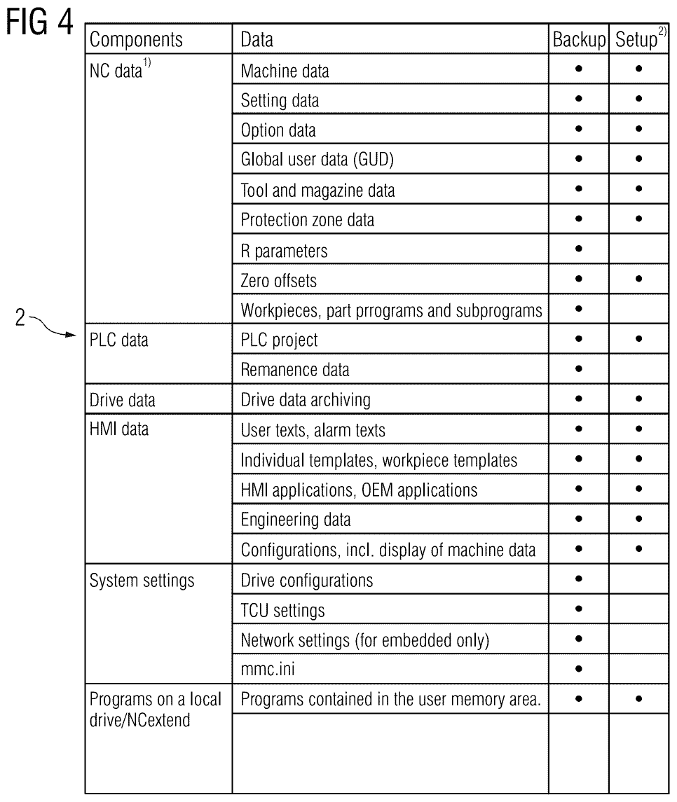

FIG. 4 shows parameter data 2 including settings and a data backup, respectively. The automation components may each include parameter data 2 that may be retrieved from that respective component. Exemplary parameter data 2 of the numerical control, NC, may include: machine data; setting data; option data; global user; tool and magazine data; protection zone data; R parameters; zero offsets; workpieces; part programs; subprograms; or any combination thereof. Exemplary parameter data 2 of the PLC may include a PLC project and/or remanence data. Exemplary parameter data 2 of the drive component may include data relating to drive torque, encoder values, setpoint speed, etc. Exemplary parameter data of the HMI component 2 may include: user texts; alarm texts; individual templates; workpiece templates; HMI applications; OEM applications; engineering data; configurations, including display of machine data; or any combination thereof. Exemplary parameter data 2 denoted as system settings (e.g., of the machine tool) of an automation component may include: drive configurations; TCU settings; network settings; mmc.ini-files; or any combination thereof. An example of parameter data 2 of one or more programs on a local drive or an NCextend drive may include one or more programs contained, for example, in a user memory area.

The parameter data 2 may be stored as binary data, and may not be modified.

Subsequently, a software component of the automation system MT (e.g., of an automation component thereof, such as of the machine tool) may collect the parameter data 2 and create the output data 1 (e.g., by combining the parameter data in a (single) output data file).

Parameter data 2 may be used to save a specific automation system or component status and to be able to restore (e.g., backup), and to set up a series of automation systems or components with the same parameter data (e.g., setup). In SINUMERIK ONE, the data storage folder (DSF) format supports these two archive types. The CNC, PLC, HMI, system settings, and drives components may be configured separately or stored together in separate files and read in again from there. The selection may be combined. The files may be used independently and be read in again with the greatest possible flexibility.

The parameter data 2 (e.g., the one or more backups) may be used to parameterize the components of a virtual machine tool (e.g., a digital twin DT of the automation system MT). In addition to the necessity of extracting and storing up the individual parameter data for parameterization from the real automation system, another challenge for the user is to modify the parameter data if necessary so that the associated virtual, digital twin component may receive the data. For example, in the early days, there was a problem for the VNCK that individual parameter data had to be modified or removed in order to parameterize the associated virtual simulation component (e.g., the digital twin component).

FIG. 5 shows a user interface 5 on a human-machine interface (HMI) control display of a machine tool MT including a control element in the form of virtual button for creating output data 1.

As described herein, the digital twin component of each automation component, such as the drive component, serves for simulating one or more functions of the respective component. This serves the purpose of making the functions of the drive component testable (e.g., in interaction between the PLC user program and the drive component). A direct data exchange between real drive components and the simulated drive components may not be possible.

According to an aspect, the user is enabled to easily retrieve the parameter data for the DT of one or more automation components from the real automation component (e.g., a device) of the real automation system. The retrieved parameter data 2 may be imported directly into the DT of this automation component 11-18 without further modification.

A user may be prompted a virtual button on a user interface of an HMI (e.g., a (touch) display) in order to save the current parameter data of the machine tool MT. A possible design with configuration option is shown in FIG. 5. Here, a complete set of parameter data or only the parameter data of individual automation components is possible.

If the recording of the parameter data 2 is selected by a user input, the parameter data 2 is written in a common output file. The output data 1 may contain information about the topology as well as the parameter data 2 of the automation components 11-18 (e.g., according to FIG. 3). This makes the output data 1 a complete picture of the conditions on the real automation system (e.g., the machine tool) and may be used for parameterizing the DT. The output data 1 and/or parameter data 2 that are suitable for directly operating the different levels of detail of the DT (e.g., different details of the drive models, such as DriveSim Basic or DriveSim Advanced) may also be generated. DriveSim Basic, for example, provides easy-to-use models for PROFIdrive-enabled SINAMICS drives, or drive components in general, that allows the creation of a digital twin (e.g., component) of the drive component. This DT allows verification and validation of the communication between the drive component and the PLC already in the planning phase. Further, this DT enables providing that the drive component and motor(s) selected fit a specific application (e.g., at the design and planning stage).

As the case may be, an automation component, and, for example, each automation component, of the automation system may be represented by one or more digital twins. In other words, an automation component may be modelled by different digital twins depending on the level of detailed desired and/or required. In other words, an automation component may be represented by a digital twin from the plurality of digital twins depending on the level of detail desired or required (e.g., to perform a simulation of the automation component and/or the automation system). Thus, the number and/or amount of parameters required to model the automation component and/or the automation system may depend on the digital twin used to model the automation component and/or the automation system. Hence, an automation component may be modelled by a plurality of digital twins (e.g., different digital twins). For example, as described herein, a drive component may be modelled by DriveSim Basic or DriveSim Advanced. Accordingly, there may be a plurality of digital twins (e.g., different digital twins) available with different levels of detail for one automation component. For example, there may be a plurality of different digital twins available for one type of automation component (e.g., for one type of automation device). The plurality of digital twins for the automation component or automation device (e.g., type) may be stored in a repository. The respective digital twin of the one or more automation components may then need to be parameterized. The central automation component may determine the parameter data for parameterizing the present digital twin of the automation system. In other words, the central automation component may determine the parameter data necessary to parameterize the digital twin of the one or more automation components of the automation system. The central automation component may then create the output data necessary or matching to the digital twin of the one or more automation components of the automation system in order for the output data to be loadable and/or suitable by the digital twin of the one or more automation components of the automation system.

For the characterization of the mechanics (e.g., static/dynamic) of the automation system MT, in addition to the mere retrieval of stored parameter data, a measurement run may be carried out to determine friction, frequency response, backlash, etc. Here, for example, auto servo tuning (AST) may be invoked. AST automates the process of adapting parameters to the control equipment, which controls the axes of a CNC machine tool. The parameters are adapted according to the frequency response measurement of the machine tool dynamics. One of the benefits of AST is that AST facilitates the measuring process. The axis control loops are individually optimized according to the target parameters selected by the user for an adaptive strategy. In a second act, the control loop parameter settings are adjusted for axes that are identified as being involved in an interpolation path, with the result that the correct dynamic response is obtained for all axes. This adaptation provides coordinated movement of all the axes along the interpolation path.

The creation of the output data 1 is not only possible via the HMI 18 of the machine tool, but may alternatively also be carried out on another networked component. The creation of the output data 1 (e.g., in the form of a data backup) may take place and/or may be initiated by a device communicatively coupled from the automation system, such as the machine tool, via any interface (e.g., USB, network, service PC, etc.).

Alternatively, the automation system may include, instead of a machine tool, one or more machines controlled by a CU320, a PLC, or a motion control system. Hence, the automation system may include networked machines and a production (e.g., completely networked production). In that case, the parameter data 2 and/or topological information may be stored by and/or retrieved from each automation component accessible in the network connecting the automation components of the automation system. The parameter data 2 may also relate to one or more software components of the automation system MT to which no dedicated hardware is assigned (e.g., such as VNCK of a machine tool) for which also a DT is required and thus may be parameterized.

The embodiments described herein provide a number of advantageous and benefits such as the creation of a parameter data and/or output data for a DT by the real automation system itself. Further, direct reading of the output data into the DT is possible without modification of the output data. The automation components present in the networked automation system may be taken into account in the parameter data and/or output data. The characteristics of the mechanics are included as part of the parameter data (e.g., backup) as part of a reference measurement (e.g., a measurement run). The user only has to press one button to create the parameter data (e.g., backup). The user has a choice regarding the automation components that should be part of the parameter (e.g., data backup). Parameter data that is suitable for directly parameterizing and thus operating the different levels of detail of the DT (e.g., different detailing of the drive models, such as DriveSim Basic or DriveSim Advanced) may be determined. Triggering and retrieval of parameter data (e.g., backup) is possible on any suitable automation component of the networked automation system. The embodiments described herein may not only be used for networked automation systems, such as CNC machines, but also in stand-alone individual drive components (e.g., for non-networked machines).

Still further advantages are that the creation of a parameter data (e.g., backup) for the DT is made at the real system itself. Further, the output data file generated as part of this data backup may be loaded directly into a DT (e.g., directly read by the digital twin). All components present in the networked automation solution may be taken into account during data backup. The characteristic of the mechanics is part of the parameter data (e.g., backup). The characteristics of the mechanics are measured during a measurement run after the start of the data backup (e.g., “one-click”). The user only has to press one button to create the parameter data (e.g., backup). The user may select individual components and start a data backup for them. A parameter data (e.g., backup) may contain parameter sets for different levels of detail of the DT(e.g., DriveSim Basic or DriveSim Advanced). A user may start the parameter data backup on any suitable automation component of the automation system (e.g., a networked manufacturing system).

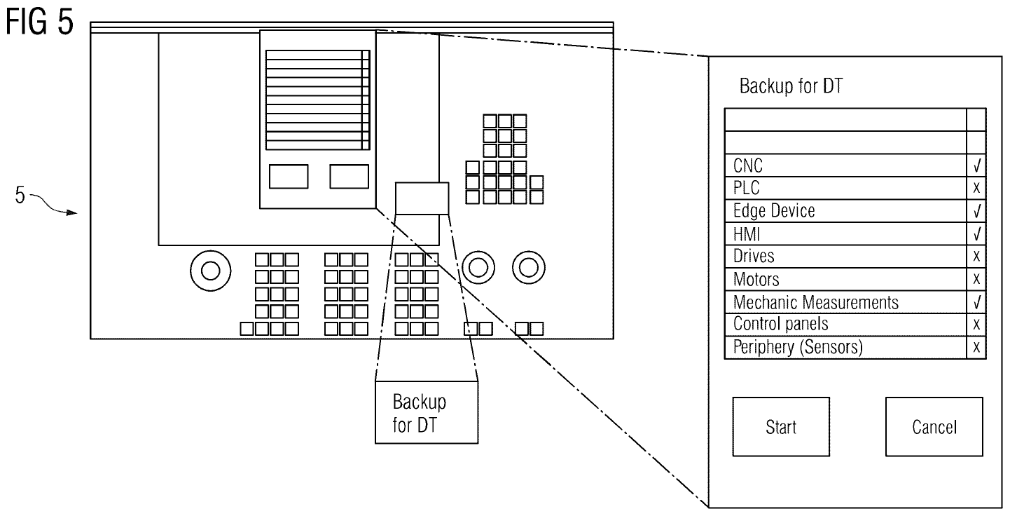

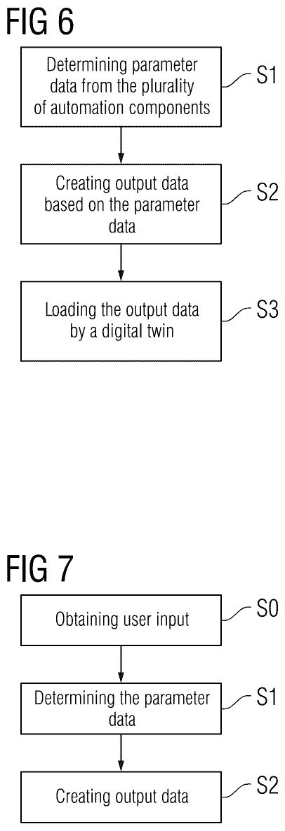

Further embodiments are described in connection with FIGS. 6 to 17.

In FIG. 6, an example of method acts is shown. In a first act S1, parameter data from a plurality of automation components of an automation system is determined (e.g., by an automation component from the plurality of automation components). The parameter data may serve for parameterizing the digital twin of the automation system. In act S2, output data is created based on the parameter data (e.g., by the automation component). The output data may include the parameter data. Additionally, the output data may include metadata relating to the date and/or user initiating the creation of the output data. The output data is loadable by the digital twin of the automation system. Hence, in act S3, the output data is loaded by the digital twin of the automation system. The parameter data serves for parameterizing the digital twin of the automation system.

As described in the above, the parameter data includes settings (e.g., a data backup) of the plurality of automation components, and/or the parameter data includes topological information about the plurality of automation components within the automation system.

In FIG. 7, an example of method acts is shown. In act S0, user input is obtained. The user input thus initiates the act S1 of determining the parameter data. The user input may be a single user input. The user input may be entered or input by a user via a user interface for operating the automation system. Subsequently, in act S2, as in the above, the output data is created.

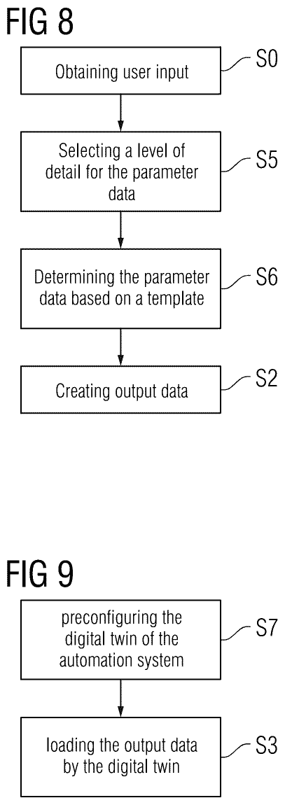

Turning to FIG. 8, a further example of method acts is shown. In act S0, as previously described, user input may be obtained. In act S5, a level of detail for the parameter data is selected, based on the user input. Again, the user input may be entered via a user interface for operating the automation system. The level of detail relates to the parameter data (e.g., in order to match the level of detail of the digital twin of the automation system). As explained earlier, a digital twin of an automation component may implement specific functionality subsets and/or the minimum required parameters of the automation component (e.g., converter control). The DT of the automation component is, for example, in the case of SINAMICS DriveSim Basic, available as a standardized functional mockup unit (FMU) and is compatible with many standard time-based simulation programs (e.g., SIMIT, Simcenter Amesim, NX Motion, or Matlab Simulink).

In order to model and simulate these properties, a certain amount and/or specific parameters may be necessary. Hence, the level of detail may thus be matched between the parameter data necessary and required for the DT to be executed. Thus, in act S6, the parameter data may be determined based on a template (e.g., by selecting the template via a user interface). The template may serve for selection of parameter data for parameterizing the digital twin of the automation system. Thus, the level of detail may be determined based on the template selected or vice versa. The template may act as a filter for selecting individual parameter data from the overall parameter data of an automation component. As before, in act S2, the output data may be created based on the parameter data obtained as just described.

Hence, for the parameter data to be determined and/or loadable by a respective digital twin of the one or more automation components of the automation system, a respective template may be used. In other words, for each digital twin of the one or more automation components of the automation system, a respective template may be available and/or used. The templates may serve for determining parameter data suitable for the various digital twins. The one or more templates may also serve for filtering the parameter data and/or for determining derived parameter data for a digital twin according to the required level of detail.

Turning to FIG. 9, in act S7, the digital twin of the automation system may be preconfigured. In other words, the DT is setup with default (e.g., factory) settings. In that state, the DT of the automation component is capable of representing different automation components (e.g., devices). It may therefore be necessary to adapt the DT to the automation system. In act S3, the output data may be loaded by the digital twin. Thus, the parameterization of the DT may be initialized and/or updated. Hitherto, the output data may be transmitted (e.g., from the automation system) to the digital twin, which is, for example, located on a computing platform that, for example, includes one or more processors and a memory.

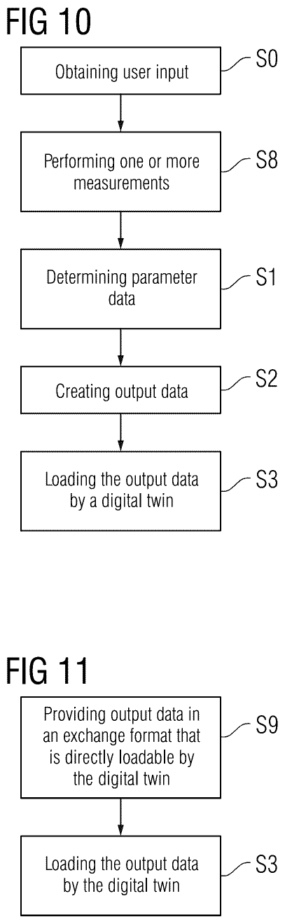

A further example of method acts is shown in FIG. 10. As before, user input may be obtained in act S0. The user input may trigger or initiate the performance of one or more measurements in act S8. Thus, the one or more measurements are initiated by the user input via the user interface. The measurements may be performed by the automation system (e.g., a reference measurement of an axis and/or spindle may be performed). Subsequently, the parameter data may be determined or updated in act S1. The one or more measurements may serve for determining one or more mechanical characteristics of the automation system (e.g., a resonance, friction, and/or backlash of at least one automation component, such as the axis or spindle). In the following, the output data may be created (e.g., which may include the (updated) parameter data) in act S2, as described herein, and the output data may then be loaded by a digital twin of the automation system, also as described herein.

The act of determining parameter data and/or the act of creating output data is performed by an automation component from the plurality of automation components or a device communicatively coupled to the automation component. Hitherto, an automation component (e.g., a central automation component) from the plurality of automation components may be used. The central automation component may be one automation component of the plurality of automation components that is operative to determine the parameter data from the plurality of automation components (e.g., each automation component of the plurality of automation components). The central automation component may be one automation component of the plurality of automation components that is operative to create the output data based on the parameter data. The central automation component may include a software component that determines and/or collects the parameter data from the plurality of automation components (e.g., each automation component of the plurality of automation components) and/or creates the output data (e.g., by combining the parameter data in a (single) output data file).

As shown in FIG. 11, the output data may be provided, by the automation system, in an exchange format that is directly loadable by the digital twin of the automation system in act S9. In a subsequent act S3, as described herein, the output data is loaded by the digital twin, and the digital twin is parameterized based on the parameter data.

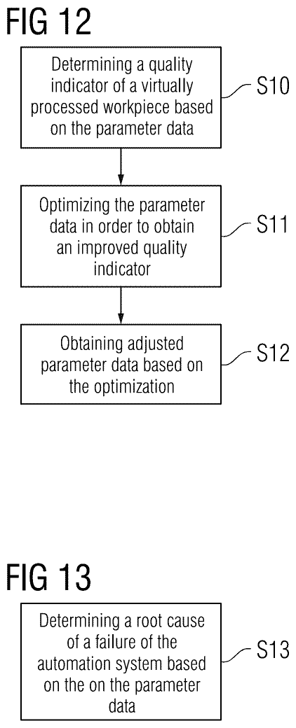

Turning to FIG. 12, the digital twin may determine a quality indicator of a virtually processed workpiece based on the parameter data in act S10. In act S11, the digital twin may optimize the parameter data in order to obtain an improved quality indicator. In act S12, the digital twin may obtain the adjusted parameter data based on the optimization. As described herein, the adjusted parameter data may be re-transmitted to the automation system in order to be applied there (e.g., (re-)loaded by the automation system and/or its automation components).

Turning to FIG. 13, the digital twin may determine a root cause of a failure of the automation system based on the parameter data in act S13. As the case may be, a failure may occur in the automation system. Based on the parameter data, the digital twin may be executed and, for example, via a variation of parameters, a root cause of the failure may be determined. The parameter data may be varied, and once an operating mode is found that does not produce the failure, a root cause may be assigned (e.g., based on the specific parameter that made the failure disappear upon its variation).

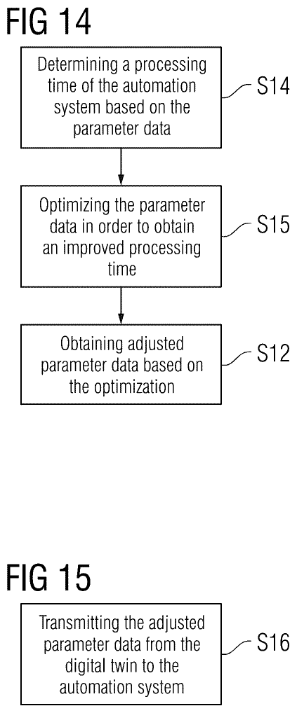

Turning to FIG. 14, the digital twin may determine a processing time of the automation system based on the parameter data in act S14. The processing time may be a machining time of a workpiece by a machine tool. In act S15, the digital twin may optimize the parameter data in order to obtain an improved processing time. In a subsequent act S12, the digital twin may obtain adjusted parameter data based on the optimization.

As shown in FIG. 15, the adjusted parameter data is transmitted from the digital twin to the automation system in act S16. At the automation system, the adjusted parameter data may be (re-)loaded by the automation system and/or the plurality of components in order to apply the adjusted parameter settings. The act S16 may be combined, for example, with any one of the method acts, as shown in FIGS. 12, 13, and/or 14.

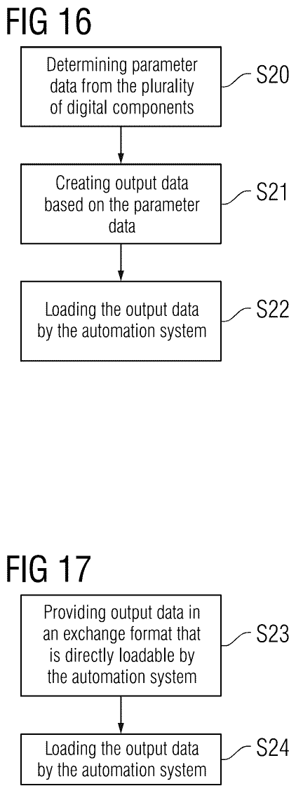

As shown in FIG. 16, an example of method acts of a method of providing output data (e.g., in an output file) for parameterizing an automation system (e.g., a machine tool) based on a digital twin of the automation system is shown. The automation system includes a plurality of automation components, and the digital twin digitally represents the automation system. The digital twin includes a plurality of digital twin components. Each digital twin component of the plurality of digital twin components digitally represents an automation component of the automation system. In act S20, a digital twin component from the plurality of digital twin components may determine parameter data from the plurality of digital twin components (e.g., the parameter data serves for parameterizing the automation system). In act S21, the digital twin component may create output data based on the parameter data. In a subsequent act S22, the output data is (re-)loaded by the automation system.

For example, the output data created by the digital twin (e.g., component) may include the adjusted parameter data, as described in FIGS. 12, 13, and/or 14.

Similar to the embodiments as already described herein, the act of determining the parameter data may be initiated by a user input (e.g., single user input) via a user interface for operating the digital twin (e.g., component).

Turning to FIG. 17, in act S23, the digital twin component may provide the output data in an exchange format. In act S24, the output data is directly loaded by the automation system. By (re-)loading the output data, the automation system may become parameterized based on the parameter data.

Thereby, a seamless parameterization of the automation system and/or the digital twin thereof is achieved.

Further embodiments may include an automation system MT (e.g., a machine tool) including one or more processors and a memory operative to perform the method acts as described herein (e.g., according to one or more of the embodiments in FIGS. 6 to 17).

Further embodiments may include a computing platform (e.g., including one or more processors and a memory) operative to perform the method acts as described herein (e.g., according to one or more of the embodiments in FIGS. 6 to 17).

Further embodiments may include a system including an automation system MT as described herein and a computing platform as described herein (e.g., according to one or more of the embodiments in FIGS. 6 to 17).

Further embodiments may include a computer program (e.g., on a non-transitory storage medium) including program code that, when executed, performs the method acts as described herein (e.g., according to one or more of the embodiments in FIGS. 6 to 17).

The elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding or following claim, whether independent or dependent. Such new combinations are to be understood as forming a part of the present specification.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. A method of providing output data for parameterizing a digital twin of an automation system, the automation system comprising a plurality of automation components, wherein the digital twin is a digital representation of the automation system, the method comprising:
determining, by an automation component from the plurality of automation components, parameter data from the plurality of automation components, wherein the parameter data is configured for parameterizing the digital twin of the automation system; and
creating, by the automation component, output data based on the parameter data, wherein the output data is loadable by the digital twin of the automation system.

2. The method of claim 1, wherein the parameter data comprises settings of the plurality of automation components, the parameter data comprises topological information about the plurality of automation components within the automation system, or a combination thereof.

3. The method of claim 1, wherein the determining of the parameter data is initiated by a user input via a user interface for operating the automation system.

4. The method of claim 1, further comprising selecting, via a user interface for operating the automation system, a level of detail for the parameter data.

5. The method of claim 4, wherein selecting the level of detail for the parameter data comprises selecting the level of detail for the parameter data, such that a level of detail of the digital twin of the automation system is matched.

6. The method of claim 1, further comprising determining the parameter data based on a template for a selection of parameter data for parameterizing the digital twin of the automation system.

7. The method of claim 6, wherein determining the parameter data based on the template comprises selecting the template via a user interface.

8. The method of claim 1, further comprising:
preconfiguring the digital twin of the automation system;
transmitting the output data to the digital twin; and
loading the output data by the digital twin.

9. The method of claim 1, further comprising:
performing, by the automation system, one or more measurements for determining, updating, or determining and updating the parameter data,
wherein the one or more measurements are configured for determining one or more mechanical characteristics of the automation system.

10. The method of claim 9, wherein the mechanical characteristics comprise a resonance, friction, backlash, or any combination thereof of at least one automation component of the plurality of automation components.

11. The method of claim 1, wherein the determining of parameter data, the creating of the output data, or the determining of the parameter data and the creating of the output data are performed by the automation component from the plurality of automation components or a device communicatively coupled to the automation component.

12. The method of claim 1, further comprising providing, by the automation system, the output data in an exchange format that is directly loadable by the digital twin of the automation system,
wherein by loading the output data, the digital twin is parameterized based on the parameter data.

13. The method of claim 1, further comprising:
determining, by the digital twin, a quality indicator of a virtually processed workpiece based on the parameter data;
optimizing, by the digital twin, the parameter data, such that an improved quality indicator is obtained; and
obtaining, by the digital twin, adjusted parameter data based on the optimization.

14. The method of claim 1, further comprising determining, by the digital twin, a root cause of a failure of the automation system based on the parameter data.

15. The method of claim 1, further comprising:
determining, by the digital twin, a processing time of the automation system based on the parameter data;
optimizing, by the digital twin, the parameter data, such that an improved processing time is obtained; and
obtaining, by the digital twin, adjusted parameter data based on the optimization.

16. The method of claim 15, wherein the processing time is a machining time of the workpiece by a machining tool.

17. The method of claim 13, further comprising transmitting the adjusted parameter data from the digital twin to the automation system.

18. A method of providing output data for parameterizing an automation system based on a digital twin of the automation system, the automation system comprising a plurality of automation components, the digital twin digitally representing the automation system, and the digital twin comprising a plurality of digital twin components, wherein each digital twin component of the plurality of digital twin components digitally represents an automation component of the automation system, the method comprising:
determining, by a digital twin component from the plurality of digital components, parameter data from the plurality of digital twin components, wherein the parameter data is configured for parameterizing the automation system; and
creating, by the digital twin component, output data based on the parameter data wherein the output data is loadable by the automation system.

19. The method of claim 18, wherein determining the parameter data is initiated by a user input via a user interface for operating the digital twin.

20. The method of claim 18, further comprising providing, by the digital twin component, the output data in an exchange format that is directly loadable by the automation system,
wherein by loading the output data, the automation system is parameterized based on the parameter data.
